(19) United States
(12) Patent Application Publication
(10) Pub. No.: US 2022/0161461 A1
(43) Pub. Date: May 26, 2022

(54) WINDMILL BLADE DISPOSAL AND RECYCLING SYSTEM

(71) Applicant: Mobile Biochar Solutions LLC, Loveland, CO (US)

(72) Inventors: James G. Gaspard, II, Loveland, CO (US); Matthew J. Chase, Windsor, CO (US); John Clay, Windsor, CO (US)

(21) Appl. No.: 17/456,077

(22) Filed: Nov. 22, 2021

Related U.S. Application Data
(60) Provisional application No. 63/198,940, filed on Nov. 24, 2020.

(51) Int. Cl. B29B 17/04

(52) U.S. Cl. CPC B29B 17/04; B29K 2309/08; B29B 2017/0496

(57) ABSTRACT

A process of fiberglass recycling, such as for windmill blades or other feedstock having a fiberglass component. An example of the process includes cutting a feedstock having a fiberglass component. After cutting the feedstock, it is fed into a controlled kiln for pyrolyzing. Pyrolysis is at a temperature of about 550-650 degrees Celsius to completely remove all resins, epoxies, and other non-fiberglass components from the feedstock to produce a fiberglass end-product.

### PRIORITY CLAIM

This application claims the priority filing benefit of U.S. Provisional Patent Application No. 63/198,940 filed Nov. 24, 2020 for “Windmill Blade Disposal And Recycling System” of Gaspard, et al., hereby incorporated by reference in its entirety for all that is disclosed as though fully set forth herein.

### BACKGROUND

Wind turbines or windmills (these terms are used interchangeably herein) are becoming more commonplace as a means for generating electricity in the United States and throughout the world. Unfortunately, these are largely mechanical devices and wear out over time. Thousands of blades are replaced each year, and most end up in conventional landfills. In the United States, it is estimated that nearly 10,000 blades are removed every year. As more wind turbines are constructed and installed, this number will only increase.

Given the intended use, these blades were constructed to withstand hurricane-force winds. The blades are not easily unassembled or crushed. As such, these take up a lot of space in landfills. This kind of land space can often only be found in the prairielands in the west, such as Iowa, South Dakota, and Wyoming. However, burying blades is only a temporary solution, as space can run out and/or state and local governments can deny that these be dumped, even on the prairieland.

### BRIEF DESCRIPTION OF THE DRAWINGS

FIG. 1 is a perspective view of an example wind turbine or windmill having multiple blades.

FIG. 2 is a photograph of an example wind turbine or windmill blade.

FIG. 3 is a perspective view of an example kiln which may be implemented in the windmill blade disposal and recycling system.

FIG. 4 is a perspective view of an example mobile kiln which may be implemented in the windmill blade disposal and recycling system.

FIG. 5 is a process diagram showing example operations of the windmill blade disposal and recycling system.

### DETAILED DESCRIPTION

A windmill blade disposal and recycling system is disclosed herein. It is noted that the systems and methods are described herein by way of illustration as these may be implemented to process windmill blades as the feedstock. However, the systems and methods can also be implemented to decontaminate fiberglass from other sources, such as fiberglass and/or other reinforced composites found in boat hulls, ship components, truck and other vehicle body components, and any of a wide variety of other sources.

In an example, the feedstock is pre-processed by cutting into strips or segments that can then be fed into one or more kiln. The blades are then pyrolyzed at a temperature (e.g., about 650 degrees Celsius) to completely remove all resins, epoxies, and/or other contaminants. The pyrolysis occurs in the kiln under a vacuum, and results in a “clean” or decontaminated fiberglass end-product and may be recovered for reuse.

In an example, the feedstock is processed with little or no emissions. Gases are combusted for clean emission utilizing the emission control system of the kiln. Oils are converted to syngas and combusted in the emission control system.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

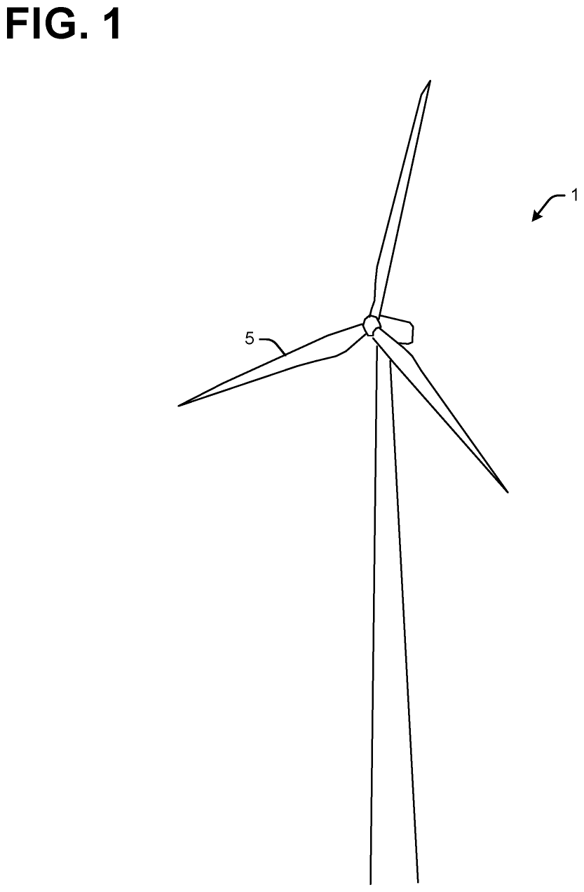

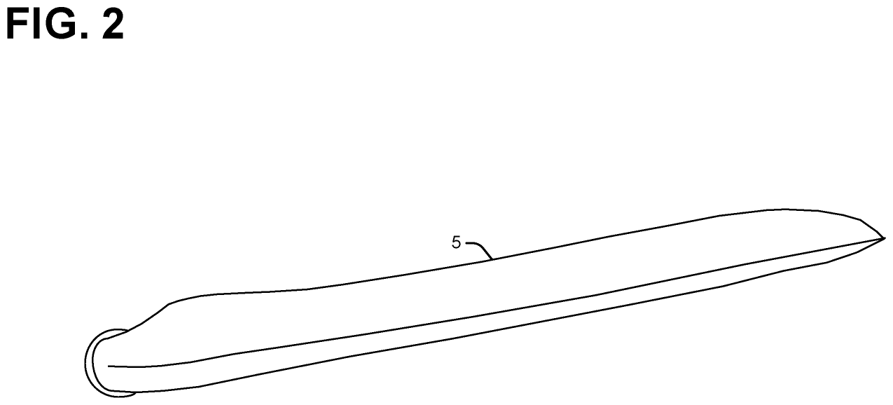

FIG. 1 is a perspective view of an example wind turbine or windmill 1 having multiple blades 5. FIG. 2 is a photograph of an example blade 5 of a wind turbine or windmill. These blades 5 were constructed to withstand hurricane-force winds. As such, the blades are not easily unassembled or disposed of. Instead, the blades may be cut. In an example, the blades are preprocessed by cutting the blades 5 into strips. The strips can be fed into the kiln.

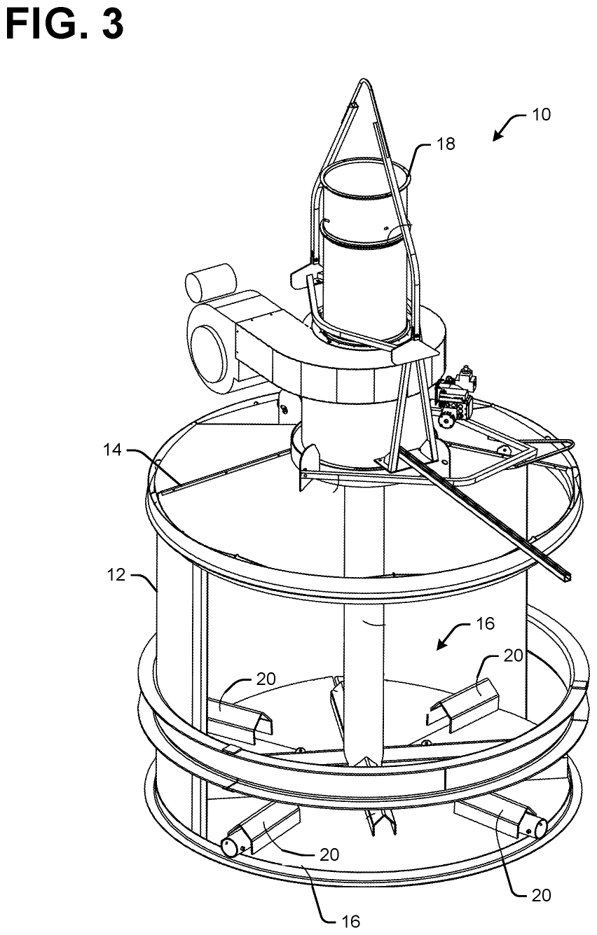

FIG. 3 is a perspective view of an example kiln 10 which may be implemented in the windmill blade disposal and recycling system. In an example, the kiln 10 may be a managed or controlled kiln that can be used itself and/or as part of a managed or controlled production plant to process blades. An example of the controlled kiln 10 which may be implemented and modified for the operations described herein is disclosed in more detail in U.S. Pat. No. 10,370,593 titled “Controlled Kiln and Manufacturing System for Biochar Production” of Aupperle, et al., and related patents.

An example of the kiln 10 includes a drum 12, a lid 14 and a floor 16 together forming a combustion chamber 18 configured to contain the blades as feedstock for conversion by pyrolysis. At least one inlet pipe 20 is configured to accept airflow into the combustion chamber 18. At least one outlet 22 is configured to release smoke and other exhaust from the combustion chamber 18.

The kiln 10 may be managed or controlled, for example, by controlling temperature, airflow, air mixing, emissions, operations reliability, and output and other parameters to control the conditions in the combustion chamber. For example, the kiln 10 may be managed or controlled by various subsystem(s), such as but not limited to, dampers, blowers, heat controls, air flow controls, mixers, monitors/sensors, computerized operating algorithms, alarms/notifications, and automated controls. A computer or computing system(s) may control motors and other actuators based on input from sensors and/or human input to adjust the operating parameters of the combustion chamber 18.

Emissions gases may be combusted for clean emission utilizing the emission control system of the controlled kiln 10. In an example, oils are converted to syngas and combusted in the emission control system of the controlled kiln 10. In another example, one or more catalytic converters may be operatively coupled with the outlet 20 to reduce or eliminate smoke, odor and/or other emissions. In either example, the kiln may be configured to incinerate emissions (e.g., toxins and greenhouse gases including particulate matter, CO, mold spores, various VOCs, and some hydrocarbons and NOX). The kiln 10 may be managed by controlling temperature, airflow, and other operating parameters to enhance operation and/or emissions.

In another example, the kiln may include a process completion subsystem. An example process completion subsystem includes a sensor configured to detect a condition of emissions and be operatively coupled to the kiln. A notification generator configured to issue notification(s) upon detection by the sensor of various condition(s).

An example system includes one or more portable kiln(s), a feedstock filling station for providing blades as feedstock to a kiln, a firing line for receiving a kiln containing the blades as feedstock, a tipping station for receiving a fiberglass material from the kiln, a crushing station to further process the fiberglass material and an automated handler configured to grasp and move the kiln between the feedstock filling station, the firing line and the tipping station. The automated handler may move the kiln itself, lift the kiln onto a trailer or other transporter for towing around to the workstations. In another example, the automated handler may be a travelling hoist system.

In an example process, the blades are cut and fed into the kiln(s). The blades are then pyrolyzed. In an example, pyrolyzing is at a temperature of about 550-650 degrees Celsius. In an example, it has been found utilizing the kiln described herein that pyrolyzing at a temperature of about 650 degrees Celsius completely removes all resins, epoxies, etc. and leaves a fiberglass end product. In an example, pyrolysis occurs in the kiln under a vacuum. Gases are combusted for clean emission utilizing the emission control system of the kiln. Oils are converted to syngas and combusted in the emission control system. In an example, the fiberglass end product is decontaminated and may be recovered for reuse.

In an example, different sections of the windmill blade may require different amounts of pyrolysis times, as there are differing amounts of epoxy and resin in the thicker sections compared to the thinner sections of the blades.

In an example, the kiln control system utilizes a control algorithm that adjusts to the differing amounts of contaminants found in the windmill blade to insure decontamination of the remaining fiberglass end product.

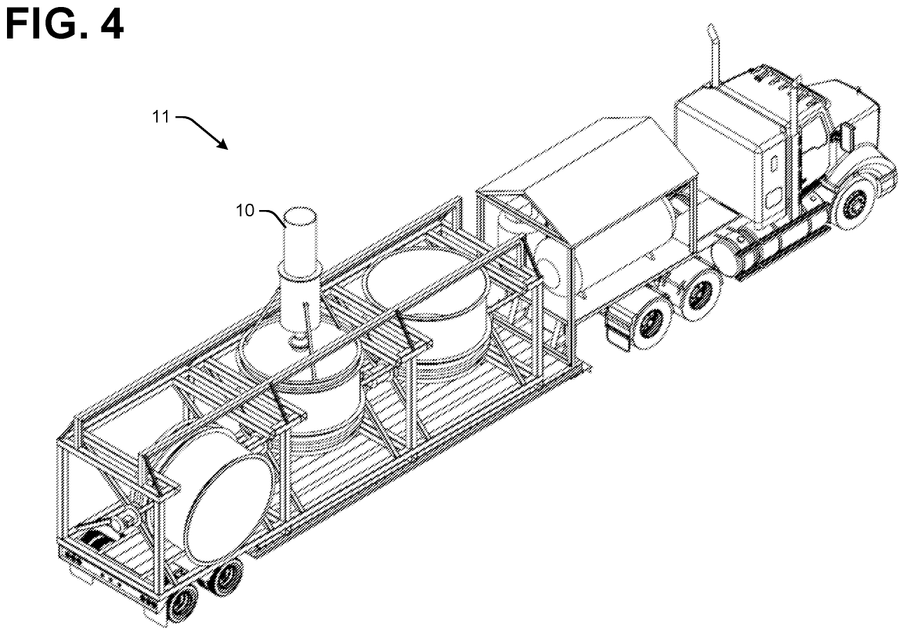

FIG. 4 is a perspective view of an example mobile kiln 11 which may be implemented in the windmill blade disposal and recycling system. The example windmill blade disposal and recycling system is shown as it may be configured for transport by a “lowboy” trailer for use on-site (e.g., where wind turbine blades are being disassembled, stored, or dumped). Other transport mechanisms (e.g., trailers, or built-on the truck) are also contemplated. Although shown in FIG. 4 as the kiln 10 may be implemented on a truck, it is understood that the mobile kiln 10 may also be transported by train.

In an example, the system is self-contained. That is, it can be fully isolated from “shore” power, with both power and fuel for the conversion process. A frame subsystem can be easily lowered on and off of a trailer. In an example operating configuration, the frame subsystem also provides the option to be permanently attached to a dedicated trailer.

In an example, a three kiln configuration such as shown in the drawings is best suited for the most efficient processing of the burn and subsequent cooling cycles. The configuration is laid out in a line so that it fits within the standard shipping requirements for transportation. The frame subsystem may be structured to support the kiln rotation pins and the overall outside geometry, so that the kilns 10 can be suspended from the frame. This structure allows for the lower frame of the kiln 10 to be removed and all kilns 10 to be supported by the frame. The frame also allows for the kilns 10 to be rotated and emptied independently after the completion of the cooling cycle.

In an example, the upper stack for the kiln 10 is provided on a rail system. The rail system enables the kiln 10 to slide down the line of kilns to limit human interaction or equipment needed for mobilizing the stack from kiln to kiln. In another example, the stacks will stay in position and are dedicated to each kiln body.

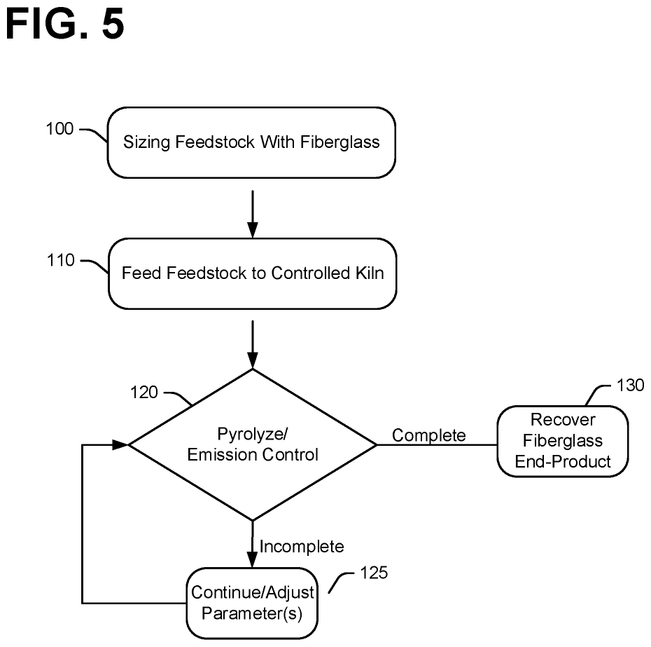

FIG. 5 is a process diagram showing example operations of the windmill blade disposal and recycling system. The operations shown and described herein are provided to illustrate example implementations. It is noted that the operations are not limited to the ordering shown. Still other operations may also be implemented.

An example process of fiberglass recycling includes operation 100 of sizing a feedstock having a fiberglass component. Example operation 110 includes feeding the feedstock into a controlled kiln. Example operation 120 includes pyrolyzing the feedstock in the controlled kiln. In an example, pyrolyzing is at a temperature of about 550 degrees Celsius. This temperature is effective to completely remove all resins, epoxies, and other non-fiberglass components from the feedstock. In an example, pyrolyzing may be under vacuum.

Example operation 125 includes continuing pyrolyzing and emission control. For example, operations may include combusting gases in an emission control system of the controlled kiln for clean emissions. Parameters may also be controlled. Example operation 130 includes recovering a fiberglass end-product.

Example operations may include adjusting at least one parameter of the controlled kiln during pyrolyzing. Example operations may also include adjusting at least one parameter of the pyrolysis for different parts of the feedstock. Example operations may also include adjusting at least one parameter of the pyrolysis for different sizes of the feedstock. Thicker feedstock may require longer burn time. Example operations may also include adjusting at least one parameter of the pyrolysis for different types of the feedstock. Feedstock which is primarily fiberglass may require less burn time and/or different temperatures and/or other controls than a feedstock which is primarily wood with a small fiberglass component. Example operations may also include adjusting pyrolysis time for different feedstocks.

Still other operations are contemplated. Example operations may also include converting oils from the feedstock to syngas, and combusting the syngas in an emission control system of the controlled kiln.

It is noted that the examples shown and described are provided for purposes of illustration and are not intended to be limiting. Still other examples are also contemplated.

1. A process of fiberglass recycling, comprising:
sizing a feedstock having a fiberglass component;
after sizing, feeding the feedstock into a controlled kiln;
pyrolyzing the feedstock in the controlled kiln at a temperature of about 550-650 degrees Celsius to completely remove all resins, epoxies, and other non-fiberglass components from the feedstock; and
recovering a fiberglass end-product.

2. The process of claim 1, wherein the feedstock is a windmill blade.

3. The process of claim 1, wherein the feedstock is a boat hull.

4. The process of claim 1, wherein the feedstock is a component of a truck or other vehicle body.

5. The process of claim 1, further comprising providing a vacuum for the pyrolysis.

6. The process of claim 1, further comprising combusting gases in an emission control system of the controlled kiln for clean emissions.

7. The process of claim 1, further comprising converting oils from the feedstock to syngas.

8. The process of claim 7, further comprising combusting the syngas in an emission control system of the controlled kiln.

9. The process of claim 1, further comprising adjusting at least one parameter of the pyrolysis for different parts of the feedstock.

10. The process of claim 1, further comprising adjusting at least one parameter of the pyrolysis for different sizes of the feedstock.

11. The process of claim 1, further comprising adjusting at least one parameter of the pyrolysis for different types of the feedstock.

12. The process of claim 1, further comprising adjusting pyrolysis time for different feedstocks.

13. A windmill blade disposal and recycling system, comprising:
a controlled kiln;
a preprocessing subsystem configured to size blades for the controlled kiln; and
a feeder subsystem configured to feed the sized blades into the controlled kiln;
wherein the blades are pyrolyzed in the controlled kiln at a temperature of about 650 degrees Celsius to completely remove all resins, epoxies, etc. and leave a fiberglass end product.

14. The system of claim 13, further comprising a vacuum in the controlled kiln for pyrolysis.

15. The system of claim 13, further comprising an emission control system to combust gases for clean emission from the controlled kiln.

16. The system of claim 13, further comprising an emission control system to convert oils to syngas for combustion.

17. The system of claim 13, further comprising a decontamination chamber to recover the fiberglass end product.

18. The system of claim 13, further comprising a control algorithm executing to adjust pyrolysis within the controlled kiln.

19. The system of claim 18, wherein the control algorithm adjusts at least one parameter of the pyrolysis for differing amounts of contaminants in the windmill blade.

20. The system of claim 13, wherein the control algorithm adjusts at least one parameter of the pyrolysis to insure decontamination of any remaining fiberglass after an initial combustion time.
